(19) United States
(12) Patent Application Publication
(10) Pub. No.: US 2020/0026726 A1
(43) Pub. Date: Jan. 23, 2020

(54) SYSTEMS AND METHODS FOR INTERACTIVE SEARCHING

(71) Applicant: Vidit, LLC, Layton, UT (US)

(72) Inventors: Rene Rodriguez, Layton, UT (US); George Michael Theodore, Greensboro, NC (US); Rodrigo Moya, Layton, UT (US)

(21) Appl. No.: 16/506,838

(22) Filed: Jul. 9, 2019

Related U.S. Application Data
(60) Provisional application No. 62/699,567, filed on Jul. 17, 2018.

(51) Int. Cl. G06F 16/58; H04W 4/029; H04L 29/06; H04L 29/08; H04N 1/00; H04W 4/21; G06F 16/51; G06F 16/29; G06F 21/62

(52) U.S. Cl. CPC G06F 16/5866; H04W 4/029; H04L 69/22; H04L 67/306; H04N 1/00122; G06F 21/6218; H04W 4/21; H04L 67/02; G06F 16/51; G06F 16/29; H04L 63/102; H04N 1/00108

(57) ABSTRACT

A system for interactive searching of an information is disclosed. The system includes a scanning module configured to enable a user to scan a view when in a location. The system includes a search module which is configured to activate a search for an information of an image of the scanned view of the predefined location, and detect a geo-marker in the scanned view of the predefined location. The system further includes a server which is configured to receive an access request of an information associated with the marker when the marker is detected by the search module, create a marker for the scanned view of the location when the marker is undetected by the search module, verify the authority of the user to access the information associated with the marker based on one or more parameters and provide the information associated with the marker to an authorized user.

### CROSS-RELATED APPLICATIONS

This application claims priority to U.S. Provisional Patent Application No. 62/699,567 which was filed Jul. 17, 2019.

### BACKGROUND

Social media are computer-mediated technologies which facilitate the creation and sharing of information, ideas and other forms of expression via virtual communities and networks. A social media platform is a web-based technology which enables the development, deployment and management of a plurality of social media solutions and a plurality of services. Using such services, the social media platform may engage individuals, communities, and organizations to share, co-create, discuss, and modify user-generated content or pre-made content posted online.

### SUMMARY OF THE INVENTION

This summary is provided to introduce a selection of concepts, in a simple manner, which are further described in the detailed description of the invention. This summary is neither intended to identify key or essential inventive concepts of the subject matter, nor to determine the scope of the invention.

In accordance with an embodiment of the present invention, a system and method for interactive searching is provided. The system includes a scanning module configured to enable a user to scan and capture an image on a smartphone. Information such as the individual's name, time of capture and location may be attached to the image. A digital geo-marker is set at the location of the capture. The image is then sent via a program on the smartphone to a server which processes the image, either video or still, and archives the image in a database along with the information sent with the image. Permissions to view the image as well as other settings may be applied to the archived image. A search is configured to locate information regarding the scanned view. The search module is also configured to detect a geo-marker at the location of the scanned view. The system includes a smartphone and a server which is configured to receive an access request associated with the marker when the geo-marker is detected by the search module. The server is further configured to create a geo-marker for the scanned view of the location when the geo-marker is undetected by the search module. The server is also configured to verify the authority of the user to access the information associated with the geo-marker based on one or more parameters. The server is further configured to provide the information associated with the geo-marker to an authorized user.

In accordance with another embodiment of the present disclosure, a method for interactive searching of an information is provided. The method includes enabling a user to scan a view when in a predefined location. The method also includes activating a search for an information of a scanned view of the predefined location. The method further includes detecting a geo-marker in the scanned view of the predefined location. The method further includes receiving an access request of an information associated with the marker when the marker is detected by the search module. The method also includes creating a geo-marker for the scanned view of the location when the marker is undetected by the search module. The method further includes verifying the authority of the user for the information associated with the marker based on one or more parameters. The method further includes providing the information associated with the marker to an authorized user.

To further clarify the advantages and features of the present invention, a more particular description of the invention will follow by reference to specific embodiments thereof, which are illustrated in the appended figures. It is to be appreciated that these figures depict only typical embodiments of the invention and are therefore not to be considered limiting in scope. The invention will be described and explained with additional specificity and detail with the appended figures.

### BRIEF DESCRIPTION OF DRAWINGS

The disclosure will be described and explained with additional specificity and detail with the accompanying figures in which:

FIG. 1 is a block diagram of a system for interactive searching of an information in accordance with an embodiment of the present disclosure;

FIG. 2 is a block diagram of an exemplary embodiment the system for interactive searching of an information of FIG. 1 in accordance with an embodiment of the present disclosure; and

FIG. 3 is a flow chart representing the steps involved in a method for interactive searching of an information of FIG. 1 in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present invention so as not to obscure the figures with details that will be readily apparent to those skilled in the art having the benefit of the description herein.

### DETAILED DESCRIPTION OF THE INVENTION

For the purpose of promoting an understanding of the principles of the invention, reference will now be made to the embodiment illustrated in the figures and specific language will be used to describe them. It will nevertheless be understood that no limitation of the scope of the invention is thereby intended. Such alterations and further modifications in the illustrated system, and such further applications of the principles of the invention as would normally occur to those skilled in the art are to be construed as being within the scope of the present invention.

It will be understood by those skilled in the art that the foregoing general description and the following detailed description are exemplary and explanatory of the invention and are not intended to be restrictive thereof.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this invention belongs. The system, methods, and examples provided herein are only illustrative and not intended to be limiting.

Embodiments of the present invention will be described below in detail with reference to the accompanying figures.

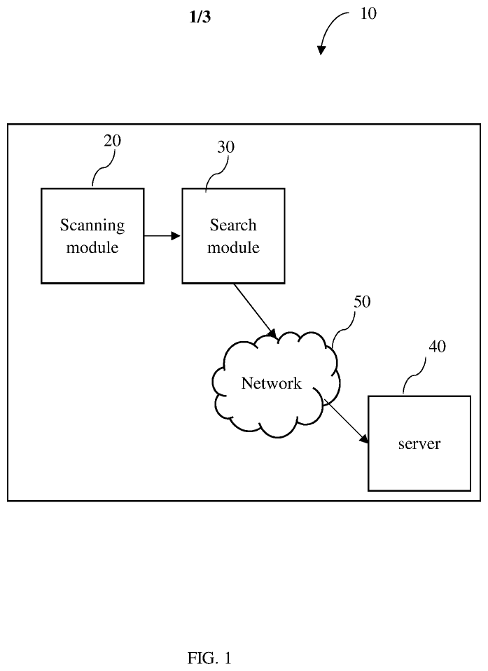

FIG. 1 is a block diagram of a system 10 for interactive searching of an information in accordance with an embodiment of the present disclosure. The system 10 is installed in a portable electronic device of a user. The system includes a scanning module 20 configured to enable a user to scan a view when in a predefined location. In one embodiment, the view may be obtained from a visual entity, a printed material, an electronic display unit, or projected visual information. In some embodiments, the scanning module 20 may include a camera or a scanner of the portable electronic device.

The system 10 also includes a search module 30 operatively coupled to the scanning module 20. The search module 30 is configured to activate a search for an information of an image of a scanned view of the predefined location. In a specific embodiment, the search module 30 may be configured to extract geographical coordinates in addition to the image in order to narrow the search. The search module 30 is also configured to detect a marker in the image of the scanned view of the predefined location. As used herein, the term “marker” is defined as the mark on an image which depicts the interactive behaviour of the image or contains information related to image. In one embodiment, the marker may be detected using a plurality of image recognition techniques. In a specific embodiment, the plurality of image recognition techniques may include at least one of optical character recognition, object recognition, and facial recognition. The system 10 further includes a server 40 communicatively coupled via a network 50 to the search module 30. The server 40 is configured to receive an access request of an information associated with the marker when the marker is detected by the search module 20.

The server 40 is further configured to create a geo-marker for the scanned view of the location when the marker is undetected by the search module 20. The server 40 is also configured to verify the authenticity of the user to access the information associated with the marker based on one or more parameters. In one embodiment, the one or ore parameters may include date, location, group membership. The server 40 is further configured to provide the information associated with the marker to an authorized user. In a specific embodiment, the information associated with the marker may include a location information, a translation information, a historic description, current news, nearby attractions, where to stay information, where to eat information, transportation related information, current currency exchange information, and the like. In some embodiments, the information associated with the maker may be obtained from online educational sources such as books, encyclopaedias, dictionaries, and translators.

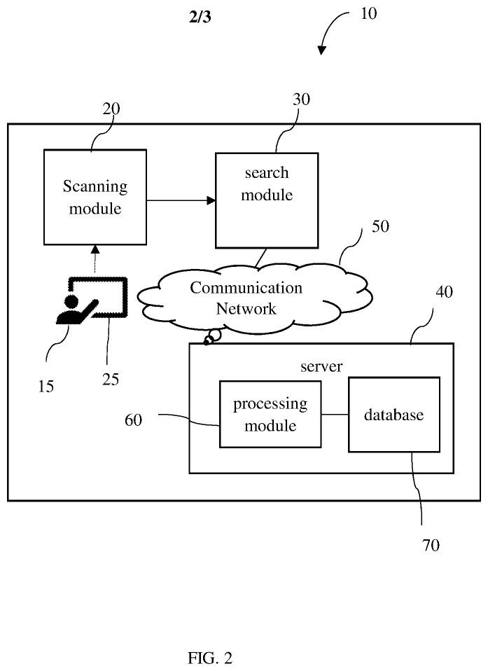

FIG. 2 is a block diagram of an exemplary embodiment of the system 10 for interactive searching of an information in accordance with an embodiment of the present disclosure. A user 15 operates a portable electronic device 25 such as a hybrid PDA or a cellular telephone with camera attachment in order to capture or scan a view of a predefined location. The system 10 is installed in the portable electronic device 25 of the user. When the user 15 reaches to a location and is unaware of the place, then to extract an information about the place, the user captures an image of a view using a scanning module 20 which is in synchronization with the camera of the portable electronic device 25.

Search module 30 processes the image, by storing the image, converting the image to a desired data-type, and/or obtaining and indexing additional information about the image. System 10 then transmits the image to the server 40 via a communication network 50. In some embodiments, the communication network 50 may include wired communication network such as LAN. In another embodiment, the communication network 50 may include a wireless communication network such as 2G, 3G, 4G, LTE, HSDPA, WiFi, Bluetooth, Zigbee, Low Power WAN and the like. After receiving the image in process, a processing module 60 associated with the server 40 performs image recognition functions of process and compares the image with images stored within a database 70 of the server 40. After detecting a marker, the database 70 extracts information associated with the image and further verify the authenticity of the user 15 to access the information. The system 10 further transmits the information to the authorized user via the communication network 50. Further, the information is displayed on a display screen or an associated display device of the portable electronic device 25 of the user.

If the search module 30 is unable to detect the marker, then the processing module 60 associated with the server 40 creates a marker for the image of the scanned view. In one embodiment, the processing module 60 creates a marker by embedding one or more attributes in the image. In such embodiment, the one or more attributes may include a video, an augmented reality video, a 3-dimensional content, a hyperlink or a text. In some embodiments, the processing module 60 may embed the viewing permission in the image. In such embodiment, the viewing permission may include a private permission representative of a permission to one or more specific people to view the image and a public permission representative of a permission to any person to view the image. After embedding the viewing permission in the image, the user 15 sends the image to the database 70 of the server 40.

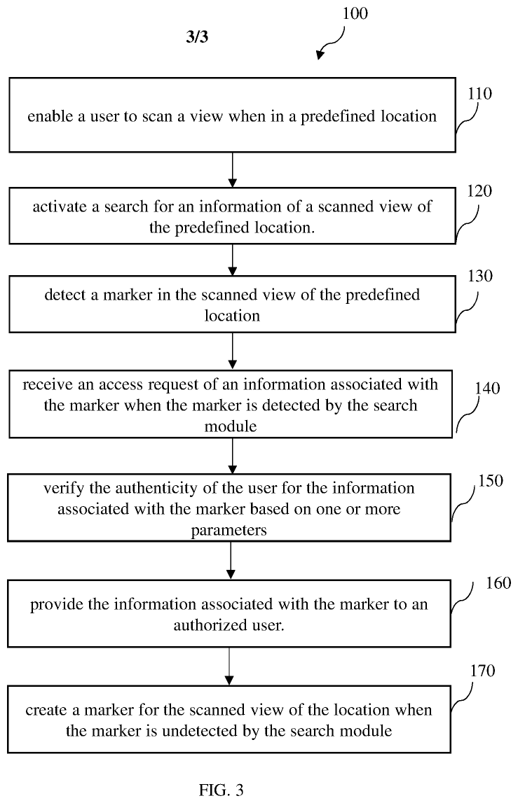

FIG. 3 is a flow chart representing the steps involved in a method 100 for interactive searching of an information in accordance with an embodiment of the present disclosure. The method 100 includes enabling a user to scan a view when in a predefined location in step 110. In one embodiment, enabling the user to scan the view when in the predefined location may include enabling the user to scan the view using a camera or a scanner of the portable electronic device when in the predefined location.

Method 100 also includes activating a search for an information of a scanned view of the predefined location in step 120. In some embodiments, the method 100 further includes extracting geographical coordinates in addition to the image in order to narrow the search. In a specific embodiment, searching the information associated with the image of the scanned view may include searching the information by processing the image, by storing the image, converting the image to a desired data-type, and/or obtaining and indexing additional information about the image. In such embodiment, searching the information associated with the image of the scanned view may include searching the information using a plurality of image recognition techniques. In a specific embodiment, recognizing the object may include at least one of performing optical character recognition, performing object recognition, and performing facial recognition. In one embodiment, searching the information using a plurality of image recognition techniques may include searching the information by comparing the image with images stored within server.

Method 100 further includes detecting a marker in the scanned view of the predefined location in step 130. The method 100 further includes receiving an access request of an information associated with the marker when the marker is detected by the search module in step 140. The method 100 further includes verifying the authenticity of the user for the information associated with the marker based on one or more parameters in step 150. The method 100 further includes providing the information associated with the marker to an authorized user 160.

Method 100 also includes creating a marker for the scanned view of the location when the marker is undetected by the search module in step 170. In one embodiment, creating a marker for the scanned view of the location may include creating the marker by embedding one or more attributes in the image by the user. In such embodiment, embedding one or more attributes in the image by the user may include embedding a video, an augmented reality video, a 3-dimensional content, a hyperlink or a text in the image. In a specific embodiment, the method 100 may include embedding the viewing permission in the image to provide the access to the user of the created marker. In such embodiment, embedding the viewing permission in the image to provide the access to the user of the created marker may include embedding a private permission representative of a permission to one or more specific people to view the image and a public permission representative of a permission to any person to view the image. The method 100 further includes sending the created marker to the server.

Various embodiments of the system and method for interactive searching of an information disclosed above enable the system to be used as a translation or dictionary guide to translate signs, written documents or the information about the location.

Furthermore, the system utilizes the camera of the portable electronic device which expanding application of the scanning module and offering convenience to the user. In addition, because the search module searches for information related to an image captured using the camera, the user may acquire the desired information simply by photographing an image of the view when in location.

While specific language has been used to describe the invention, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

We claim:

1. A system for creating a data packet having an image, a geo-marker, a date stamp and permissioning and searching a database of similar data packets comprising:
creating a profile of a user;
capturing an image and placing it in a data packet;
placing a geo-marker at the site of the image acquisition and memorialized in the data packet;
associating with the image in the data packet information about the profile of the user who captured the image and permissioning allowed by the user through the profile or specifically for the image;
creating a server request;
sending the server request to a server with the data packet;
processing on the server the data packet;
storing the processed data packet; and
searching the database of stored processed data packets by user, location of image capture, time of capture, image content or other characteristics all available on a permission-based system.

2. A system as recited in claim 1, wherein searching may occur by a smartphone for geo-markers in the vicinity of the smartphone.

3. A system as recited in claim 2, wherein the profile of the user contains the user's name, the area in which a majority of geo-markers set by the user are located, permissioning restrictions or the user's age.

4. A system as recited in claim 1, wherein the image is a photograph.

5. A system as recited in claim 1, wherein the image is a video.

6. A system as recited in claim 1, wherein the image is an augmented reality video.

7. A system as recited in claim 1, wherein the image is 3 dimensional.

8. A system as recited in claim 1, wherein the image is a hyperlink.

9. A system as recited in claim 1, wherein the image is a text.

10. A system as recited in claim 1, wherein the image is a QR code.

11. A system as recited in claim 1, wherein the image is a bar code.

12. A system as recited in claim 1, wherein the image is a digital encoded tag.
